(19) United States
(12) Patent Application Publication
(10) Pub. No.: US 2007/0151838 A1
(43) Pub. Date: Jul. 5, 2007

(54) Electronic device keypad

(76) Inventors: Louis J. Lundell, Buffalo Grove, IL (US); Patrick Cauwels, South Beloit, IL (US)

Correspondence Address: MOTOROLA INC, 600 NORTH US HIGHWAY 45, ROOM AS437, LIBERTYVILLE, IL, 60048-5343, US

(21) Appl. No.: 11/325,863

(22) Filed: Jan. 5, 2006

(51) Int. Cl. H01H 1/10

(52) U.S. Cl. 200/512

(57) ABSTRACT

A keypad (102) for entering data in an electronic device (100) is disclosed. The keypad includes a thin circuit (202) with a first side (302) and a second side (304). The keypad also includes a user interface (204) located on the first side of the thin circuit. In addition, the keypad includes a dome array system (206) coupled to the second side of the thin circuit.

### FIELD

The present disclosure relates in general to the field of electronic devices, and more specifically to keypads for these electronic devices.

### BACKGROUND

Electronic devices such as mobile phones, pagers, Personal Data Assistants (PDAs), hand held games, and so forth, are being increasingly used these days. One of the features of electronic devices includes convenient data entry. Current methods for data entry include using keypads, touch screen displays, external keyboards attached to the electronic devices, and so forth.

Existing keypads include a user interface, a dome array system, and a printed circuit board. The user interface includes multiple keys. The dome array system includes multiple domes and multiple plungers. The keypad includes an additional keypad component that carries the domes and the plungers. The plungers are positioned below the user interface and above the domes. The plungers usually form a part of the keypad itself. The domes and plungers can also be integrated with each other.

To help with decreasing the size of electronic devices such as mobile phones, the corresponding sizes of the keypads can be reduced. Unfortunately, the existing constructions of keypads suffer from the disadvantage of being bulky and large, on account of one or more of the above-mentioned components. Thus, there is a need for an improved keypad for entering data on an electronic device.

### SUMMARY

Various embodiments of the present disclosure provide a keypad for entering data in an electronic device. The keypad includes a thin circuit having a first side and a second side. The keypad further includes a user interface located on the first side of the thin circuit, and a dome array system located on the second side of the thin circuit.

### BRIEF DESCRIPTION OF THE FIGURES

The present disclosure is illustrated by way of example, and not limitation, in the accompanying figures, in which like references indicate similar elements, and in which:

FIG. 1 illustrates an electronic device incorporating a keypad coupled to a housing, in accordance with an embodiment of the present disclosure.

FIG. 2 illustrates various components of the keypad, in accordance with an embodiment of the present disclosure.

FIG. 3 illustrates a section of a key of the keypad, in accordance with an embodiment of the present disclosure.

FIG. 4 illustrates a section of a key of the keypad, in accordance with another embodiment of the present disclosure.

FIG. 5 illustrates a section of a key of the keypad, in accordance with yet another embodiment of the present disclosure.

FIG. 6 illustrates a thin circuit, in accordance with an embodiment of the present disclosure.

FIG. 7 illustrates an arrangement of the various components of the keypad, in accordance with an embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION

Before describing in detail the electronic device keypad in accordance with the present disclosure, it should be observed that the present disclosure resides primarily in combinations of apparatus components related to the keypad for the electronic device. Accordingly, the apparatus components have been represented where appropriate by conventional symbols in the drawings, showing only those specific details that are pertinent to understanding the present disclosure so as not to obscure the disclosure with details that will be readily apparent to those of ordinary skill in the art having the benefit of the description herein.

In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “an,” or the like does not, without more constraints, preclude the existence of additional identical elements in the process, method, article, or apparatus that comprises the element.

The term “another,” as used herein, is defined as at least a second or more. The terms “including” and/or “having,” as used herein, are defined as comprising.

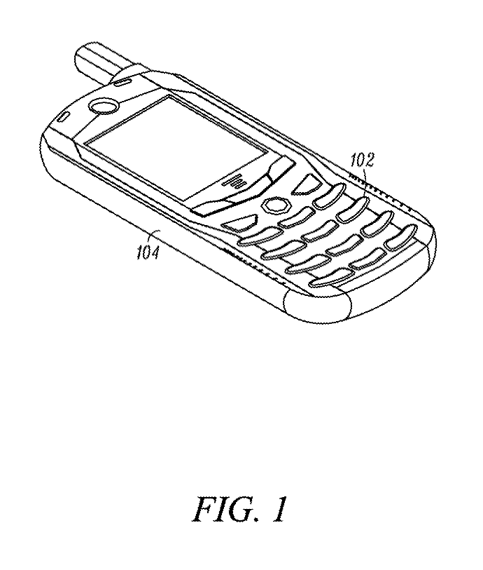

FIG. 1 illustrates an electronic device 100 incorporating a keypad 102 coupled to a housing 104, in accordance with an embodiment of the present disclosure. Examples of the electronic device 100 can include, but are not limited to, a mobile phone, a computer, a laptop, a Personal Digital Assistant, a handheld game, and the like. The keypad 102 is used for entering data in the electronic device 100. The housing 104 includes a frame for holding the keypad 102 and other essential components of the electronic device 100. Thus, the housing 104 may be a housing, a frame, a sub-housing, or the like.

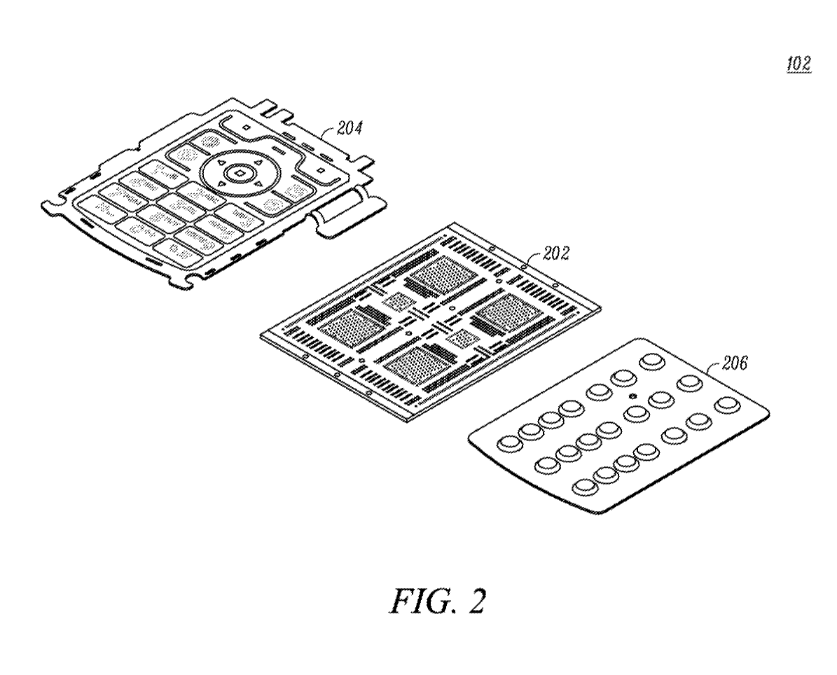

FIG. 2 illustrates various components of the keypad 102, in accordance with an embodiment of the present disclosure. The keypad 102 includes a thin circuit 202, a user interface 204, and a dome array system 206. In an embodiment of the present disclosure, the thin circuit 202 is a flexible printed circuit. The flexible printed circuit can be a laminate construction of a conductive and a non-conductive film. The user interface 204 includes one or more keys and is located on one side of the thin circuit 202 or exists as an integral part of the thin circuit 202. In an embodiment of the present disclosure, the user interface 204 includes a touchpad. The dome array system 206 includes one or more domes and one or more plungers, and is located on another side of the thin circuit 202.

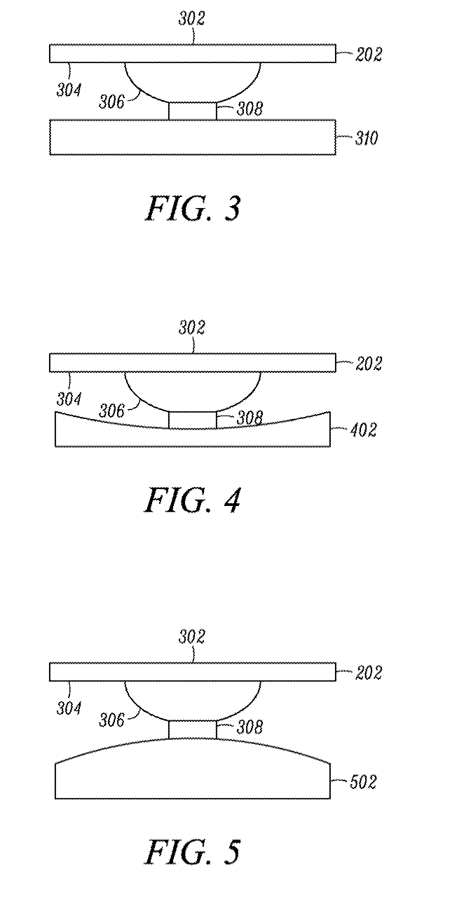

FIG. 3 illustrates a section of a key of the keypad 102, in accordance an embodiment of the present disclosure. The thin circuit 202 includes a first side 302 and a second side 304. The first side 302 of the thin circuit 202 faces an exterior of the housing 104, and includes the user interface 204. Examples of the user interface 204 can include, but are not limited to, a sticker, a metallic sheet with key designs and the so forth. The user interface 204 can be directly inked or otherwise fabricated into the thin circuit 202. Since the thin circuit 202 can be a flexible circuit board, the thin circuit can bend and tactile pressure can be directly applied on it. The second side 304 of the thin circuit 202 can include a pattern of conductors, created on a bendable film, to form an electrical circuit. The bendable film can act as an insulating base material. A dome 306 can be in contact with the second side 304 of the thin circuit 202. In an embodiment of the present disclosure, the dome 306 can be made of electrically conductive material such as steel, gold or any other conductive material. The shape of the dome 306 can be hemispherical, semi hemispherical and the like. A plunger 308 is engaged to the dome 306. In an embodiment of the present disclosure, the plunger 308 can be integrated with the dome 306. The plunger 308 can be attached to the curved side of the dome 306. In another embodiment of the present disclosure, the plunger 308 can be aligned with the dome 306. In other words, the plunger 308 and the dome 306 are operatively coupled with each other. In yet another embodiment, the plunger 308 can be integrated with the housing 104. The materials used for making the plunger 308 can include, but are not limited to, silicone, polycarbonate, rubber, and so forth. In an embodiment of the present disclosure, the diameter of the dome 306 can typically vary between 4 mm and 5 mm. For the above-mentioned diameter range of the dome 306, the diameter of the plunger 308 can typically vary between 1 mm and 2 mm. The plunger 308 can rest on a surface 310 of the housing 104. The surface 310 of the housing 104 can be either a flat surface or a curved surface.

The user interface 204 can include one or more keys. In an embodiment of the present disclosure, the dome 306 completes the electrical circuit on the second side 304 of the thin circuit 202, when a corresponding key on the user interface 204 is pressed. Pressing a key from the one or more keys on the user interface 204 includes applying tactile pressure on the thin circuit 202 through the key. On application of pressure, the dome 306 is depressed between the thin circuit 202 and the plunger 308, thereby completing the electrical circuit.

FIG. 4 illustrates a section of a key of the keypad 102, in accordance with another embodiment of the present disclosure. In this embodiment the electronic device 100 is curved. The surface 402 of the housing 104 can be a concave surface. The dome 306 makes contact with the thin circuit 202 placed above the dome 306 on application of pressure. The surface 402 of the housing 104 acts as a support. A geometric contact is formed between the dome 306 and the thin circuit 202 irrespective of the shape of surface 402 of the housing 104.This makes the keypad 102 kinematically stable and independent of the geometry of the housing 104.

FIG. 5 illustrates a section of a key of the keypad, in accordance with yet another embodiment of the present disclosure. In this embodiment, the electronic device 100 is curved. The surface 502 of the housing 104 can be a convex surface. The functioning of the keypad 102 is similar to the embodiment explained in conjunction with FIG. 4.

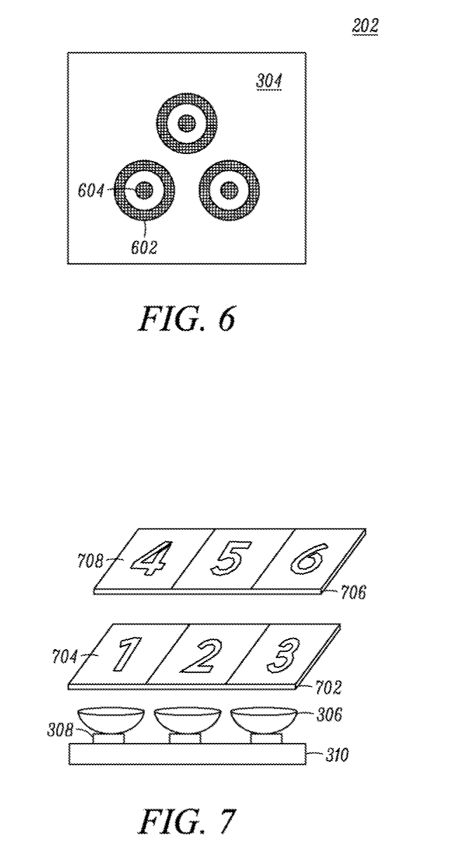

FIG. 6 illustrates the thin circuit 202, in accordance with an embodiment of the present disclosure. The second side 304 of the thin circuit 202 can include a conductive outer portion 602 and a conductive inner portion 604, corresponding to each key on the user interface 204. The base perimeter of the dome 306, resides on the conductive outer portion 602 with an apex of the dome 306 over the conductive inner portion 604. On application of pressure on the corresponding key on the user interface 204, the dome 306 collapses to a flat shape. The collapsed dome 306 can act as an electrical contact between the conductive outer portion 602 and the conductive inner portion 604, and can complete the electrical circuit. Geometrical shapes of the pattern of conductors on the electrical circuit have been shown to be circular, for exemplary purposes. It should be noted that similar functionality can also be achieved using different geometrical patterns of the conductors. For example, in an embodiment of the present disclosure, the outer ring 602 may be a split-ring and the dome 306 in the collapsed condition may complete the electrical circuit by connecting the split portions.

FIG. 7 illustrates a relative arrangement of the various components of the keypad 102, in accordance with an embodiment of the present disclosure. The keypad 102 can include one or more domes and one or more plungers integrated to form dome plunger assemblies. For example, the dome 306 and the plunger 308 integrate to form a dome plunger assembly. The dome-plunger assembly is inverted so that the plunger 308 interacts with the surface 310 of the housing 104. In this case, the relative arrangement of the thin circuit 702, a user interface 704, the dome plunger assembly, and the surface 310 of the housing no longer form a critical design requirement. This makes the one or more keys of the user interface 704 position variable and interchangeable. For example, the thin circuit 702 along with the user interface 704 can be replaced by a thin circuit 706 with a different user interface 708 without affecting the functioning of the keypad 102. The thin circuits 702 and 706 are the same as the thin circuit 202 described in detail in conjunction with FIG. 2. The user interfaces 704 and 708 are the same as the user interface 204 described in detail in conjunction with FIG. 2.

In another embodiment of the present disclosure, the dome plunger assembly as described above is integrated with the thin circuit 202. The user interface 204 is located on the first side 302 of the thin circuit 202. In this case, an entire system including the thin circuit 202, the user interface 204, and the dome plunger assembly can be conveniently replaced and interchanged with another system including a different pattern of keys on the user interface 204.

In another embodiment of the present disclosure, the user interface 204 is a touchpad. The second side 304 of the thin circuit 202 includes a touch sensing circuitry to enable touchpad functionality with the key functions. In an embodiment of the present disclosure, the first side 302 of the thin circuit 202 can have dual action keys. The response of the dual action keys depends on the magnitude of tactile pressure applied. In other words, the dual action keys respond in a one manner when the tactile pressure applied is less than a threshold, and respond in a different manner when the tactile pressure applied is more than the threshold. For example if the electronic device 100 is a mobile phone including a camera, a dual action key can be used for focusing the lens when the tactile pressure applied on it is less than the threshold. The dual action key can be used to take a photograph when the tactile pressure is more than the threshold.

In an embodiment of the present disclosure, the keypad 102 also includes an Electro Luminescent (EL) panel for providing at least one of a front lighting and a back lighting to the electronic device 100.

As described above, the keypad provided in the present disclosure has a reduced size due to the integration of the thin circuit and the user interface. Further, the disclosure enables good key performance for range of associated housing geometries, where the related surface may be flat to concave to convex. Further, the disclosure enables the integration of touch pad functions and key press functions in a single keypad. In addition, the keys on the user interface are position variable.

It is expected that one of ordinary skill, notwithstanding possibly significant effort and many design choices motivated by, for example, available time, current technology, and economic considerations, when guided by the concepts and principles disclosed herein will be readily capable of such keypads with minimal experimentation. In the foregoing specification, the disclosure and its benefits and advantages have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

What is claimed is:

1. A keypad for entering data in an electronic device, the keypad comprising:
a thin circuit having a first side and a second side;
a user interface having one or more keys, the user interface located on the first side of the thin circuit; and
a dome array system located on the second side of the thin circuit.

2. The keypad of claim 1, wherein the dome array system comprises:
one or more domes; and
one or more plungers engaged to the one or more domes.

3. The keypad of claim 2, wherein the one or more domes are in contact with the second side of the thin circuit.

4. The keypad of claim 3, wherein the one or more plungers are engaged to curved portion of the one or more domes.

5. The keypad of claim 1, wherein the thin circuit comprises a touch sensing circuitry to enable touchpad functions.

6. The keypad of claim 1, wherein the keypad further comprises an Electro Luminescent panel.

7. The keypad of claim 1, wherein the thin circuit is a flexible printed circuit.

8. The keypad of claim 1, wherein the one or more keys are position variable.

9. An electronic device comprising:
a housing; and
a keypad coupled to the housing, the keypad comprising:
a thin circuit having a first side and a second side, the first side facing an exterior of the housing;
a user interface coupled directly to the first side of the thin circuit, the user interface having one or more keys; and
a dome array system located on the second side of the thin circuit.

10. The electronic device of claim 9, wherein the dome array system comprises:
one or more domes; and
one or more plungers engaged to the one or more domes.

11. The electronic device of claim 10, wherein the one or more domes are in contact with the second side of the thin circuit.

12. The electronic device of claim 11, wherein the one or more plungers are engaged to curved portion of the one or more domes.

13. The electronic device of claim 10, wherein the one or more plungers are integrated with the housing.

14. The electronic device of claim 10, wherein the one or more plungers are integrated with the one or more domes.

15. The electronic device of claim 9, wherein the thin circuit comprises a touch sensing circuitry to enable touchpad functions.

16. The electronic device of claim 9, wherein the keypad further comprising an Electro Luminescent panel.

17. The electronic device of claim 9, wherein the thin circuit is a flexible printed circuit.

18. The electronic device of claim 9, wherein the one or more keys are position variable.

19. The electronic device of claim 9, wherein the housing is at least one of a flat housing and a curved housing.

20. The electronic device of claim 19, wherein the curved housing is at least one of a concave housing and a convex housing.
